(19) United States
(12) Patent Application Publication
(10) Pub. No.: US 2004/0022925 A1
(43) Pub. Date: Feb. 5, 2004

(54) Soups with improved particulate suspension characteristics

(76) Inventors: Lawrence Freedman, Cheshire, CT (US); Joseph A. Ackilli, South Salem, NY (US); Harry H. Topalian, Weston, CT (US)

Correspondence Address: Eric A. Dichter, Wolf, Block, Schorr and Solis-Cohen LLP, 22nd Floor, 1650 Arch Street, Philadelphia, PA, 19103, US

(21) Appl. No.: 10/632,397

(22) Filed: Jul. 31, 2003

Related U.S. Application Data
(60) Provisional application No. 60/400,388, filed on Jul. 31, 2002.

(51) Int. Cl. A23K 1/00

(52) U.S. Cl. 426/615; 426/622

(57) ABSTRACT

A process for making soup, sauce, and gravy, and a soup, sauce, or gravy composition, utilizes a physically-modified starch. The soup, sauce, or gravy may be organic, has a homogeneous appearance, and is capable of being filled into containers. The starch is heated and held during the process of manufacturing the soup, sauce, or gravy, which allows bulky ingredients, such as vegetables, legumes, bulgur wheat, barley, fruits, rice, and pasta, to be subsequently added to form a generally homogeneous blend that is maintained during further processing and during the shelf life of the product.

### CROSS-REFERENCE TO RELATED APPLICATION

This application claims the benefit of U.S. Provisional Application No. 60/400,388, filed Jul. 31, 2002, the entire disclosure of which is incorporated herein by reference.

### FIELD OF INVENTION

The present invention relates to ready-to-serve soups, sauces, and gravies and methods for making the same. More particularly, the present invention is directed to incorporating a physically-modified plant-derived starch into soup, sauce, or stock to improve appearance/homogeneity.

### BACKGROUND

It has become increasingly popular in recent years to package soups and sauces in clear glass containers so that the food product may be viewed by the consumer prior to purchase and during storage prior to consumption. One of the problems with food products that contain ingredients that settle out from solution (e.g., rise to the top of the container), such as vegetables, or which may separate into different phases, such as aqueous and fatty layers, is that the product may appear unappetizing when packaged in a clear container. In addition, a non-homogeneous mixture may form during processing of the product which may create problems in uniformly filling the containers.

Several approaches have been taken in order to address these problems. In order to fill containers uniformly during processing, vegetables and other bulky or particulate ingredients have been added to containers separately from liquid ingredients. Nevertheless, this approach did not solve the problem of the homogeneity of appearance of the product in the clear glass container. Others have taken the approach of adding chemically-modified starch which would provide high viscosity to suspend the bulky or particulate ingredients. However, such starches are unsuitable for organic soup products because chemically modified starches are not permitted pursuant to current health regulations. See National List of Allowed and Prohibited Substances, 7 C.F.R. §§ 205.600-205.606 (2001). Starches permitted for organic foods pursuant to these standards have heretofore failed to accomplish the desired suspension characteristics in the organic product due to undesired thickening during sterilization.

Thus, there is a need for soups, sauces, and gravies that exhibit little or no phase separation from the time of production and continuing over the expected shelf-life of the product for facilitating filling of containers, and improving the appearance of a jarred product.

### SUMMARY OF THE INVENTION

This invention comprises a process for manufacturing soups, sauces, and gravies, and these soup, sauce, and gravy compositions in which a physically modified, plant-derived starch is utilized to suspend bulky ingredients and to keep the bulky ingredients suspended during the processing, particularly filling, and the expected shelf life of the product. The starch is able to withstand temperatures of about 260° F. (127° C.). The process includes forming an admixture of dry ingredients and the starch, adding liquid ingredients to the admixture to form a powder slurry, and heating the powder slurry for a sufficient time to allow swelling of the starch to occur, and forming a swelled soup, sauce, or gravy base. Preferably, the powder slurry is heated to between about 160° F. (71° C.) and about 200° F. (93° C.), more preferably to about 195° F. (91° C.), for about 15 to 30 minutes, preferably, approximately 20 minutes.

Bulky ingredients can then be added to the swelled soup base to form a bulk soup, sauce, or gravy, which is heated sufficiently to sterilize the bulk soup, gravy, or sauce to form shelf-stable, ready to serve soup, gravy, or sauce. Preferably, containers such as glass jars are filled with the bulk soup, sauce, or gravy prior to sterilization. Sterilization is accomplished via retorting. The process allows for a generally homogeneous product to be filled into the containers.

In a preferred embodiment, the starch component comprises about 0.2-4.0%, more preferably about 0.5-2.0%, and even more preferably about 1.8% by weight of the soup, sauce, or gravy made according to the process of the invention.

In another embodiment, the physically-modified starch is made from organically grown corn or maize.

In yet another embodiment, the physically modified starch has the properties of a physically-modified, waxy corn starch, such as the commercially available starches Novation 2300OC and Novation 9230 available from National Starch and Chemical Company, Bridgewater, N.J.

### DETAILED DESCRIPTION OF THE INVENTION

For purposes of convenience, the compositions of the invention will hereinafter be referred to collectively as soups, and it should be understood that the term “soup” is intended to encompass soups, sauces, gravies, combinations of soups, sauces, and gravies, and similar food compositions.

Ready-to-serve soups, gravies, and sauces which exhibit little or no phase separation from the time of production and continuing over the expected shelf life of the product are prepared through specified processing steps and use of an appropriate physically-modified starch.

In general, the soup compositions of the invention will contain dry ingredients including, but not limited to, herbs, spices, cane sugar, salt, and dry, non-fat, whole, and/or reduced-fat milk. Dry ingredients are selected to provide desired flavor properties, and may or may not be water soluble. For organic soups, the ingredients must meet accepted standards which can be found in National List of Allowed and Prohibited Substances, 7 C.F.R. §§ 205.600-205.606 (2001).

The dry ingredients are mixed with an appropriate physically-modified starch. An appropriate starch is of plant origin, and preferably from waxy corn or waxy maize. The corn or maize from which the starch is made may be organically grown. The appropriate starch is suitable for high temperature (ca. 260° F.; 127° C.) and high shear processes such that the starch's polymer backbone does not break down. The starch should exhibit a smooth short texture upon cooking without settling to a gel. In one embodiment, the starch is off-white to cream-colored, is in the form of a fine powder, has approximately 12% moisture content, and has a pH of about 6.

The physical (non-chemical) modification of the starch enables it to be incorporated into organic and natural food products. The physical modification includes, without limitation, subjecting the naturally-occurring starch to shearing forces.

A test that can be conducted to determine if a physically modified starch is appropriate is a Brabender test of viscosity of a 5% by weight heated starch slurry. A Visco Amylograph Model PT-100 apparatus available from C. W. Brabender Instruments Inc., S. Hackensack, N.J. may be used for viscosity tests. Preferred physically-modified starches will exhibit results of the order of 250-500 Brabender Units (BU) @ 92° C. and 425-625 BU @ 92° C.+15 Minutes. Preferred starches are Novation 2300OC and Novation 9230 available from National Starch and Chemical Company, Bridgewater, N.J..

In addition to the Brabender viscosity tests, a preferred starch may be selected by a visual separation test of stability during storage under refrigerated conditions and elevated temperatures. To conduct this test, one prepares a 3-4% starch slurry with water and subjects the slurry to either refrigeration at 35-45° F. (2-7° C.) or heating at 90-120° F. (32-49° C.). The cooled or heated slurry is observed for separation or gel formation approximately eight weeks later.

The starch is a candidate for the process of this invention if separation is minimal. Confirmation of starch suitability may be made by a pilot test using the starch in the process for making a soup, sauce, or gravy and determining that it exhibits minimal phase separation and good suspension of bulky ingredients for a desired period of time.

The starch component forms about 0.2% to about 4% by weight of the soup composition. More preferably, the starch comprises from about 0.5% to about 2.0% by weight of the soup composition. In a preferred embodiment, the starch comprises about 1.8% by weight of the soup composition. Dry ingredients such as sugar, salt, dry milk, and spices may be added for taste and may comprise from about 1% to about 4% by weight of the composition, preferably about 2.5% to about 3% by weight.

Once an admixture comprising the dry ingredients and starch is formed, water is added to the admixture and mixing undertaken until a smooth powder slurry is formed. Other liquid ingredients, such as broth or juice, preferably organic, may be used instead of, or in addition to, water. A commercial powder slurry mixer, such as the Breddo Mixer (Breddo Likwifier, Kansas City, Mo.) is preferably utilized. The amount of water is generally from about 40% to about 60% by weight, preferably about 45% to about 55%, more preferably about 50%. The amount of water utilized depends on the consistency of soup desired, the amount and type of starch, and the amount and type of other ingredients. Generally, the ratio of starch to water is at least 1.5%.

Vegetable puree may also be added at this time if desired as an ingredient of the soup, sauce, or gravy. Organic butter or other fats may be also added at this stage; however, it is desirable to utilize no more than about 2% by weight of added fat, preferably about 0.5% or less.

A soup saute step to form a swelled soup base is then employed in order to achieve the desired consistency and prevent thickening during the later sterilization (retort) stage. The powder slurry is heated at a sufficient temperature, to between about 160 and about 200° F. (about 71-93° C.), for a sufficient length of time to swell the starch and to thereby form a swelled soup base. Preferably, the powder slurry is heated to about 195° F. (91° C.) for about twenty minutes. Preferably, the powder slurry is pumped to an agitated steam jacketed kettle and heated therein. A suitable kettle can be obtained from Groen (Jackson, Miss.).

The viscosity of the swelled soup base may be used to determine if it has swelled sufficiently. A Bostwick Consistometer measurement may be used for between about 10 and about 60 seconds, preferably for about 30 seconds, to ensure the swelled soup base meets desired specifications. An acceptable flow rate is from about 10 cm to about 23 cm, preferably about 12 cm to about 18 cm, per 30 seconds.

If bulky ingredients, such as beans, lentils, pasta, or rice, are to be added to the product, it is preferable to precook these ingredients. For example, rice may be precooked by boiling for approximately 30 minutes. These types of bulky ingredients are thereby fully cooked in order to avoid further hydration during subsequent retorting steps. It has been found that avoiding further hydration will improve suspension and minimize further thickening of the soup through the retort process.

The soup may comprise about 5% to about 50% bulky ingredients. Preferably, the amount of bulky ingredients is about 35% or less by weight.

Remaining ingredients, such as blanched rice, chopped vegetables, or cream are then added to the swelled soup base to form bulk soup. Bulk soup is heated and pumped into the surge kettle, where it is thoroughly mixed. The bulk soup is preferably heated to about 160° F. (71° C.) to minimize air, inactivate enzymes, and minimize sterilization time in further steps. From the surge kettle, the product is pumped to a filler device that pours the product into containers. Preferably, the containers are transparent, such as glass jars, which will permit the consumer to view the contents, however, any other containers capable of being retorted may be used.

The containers are preferably retorted for sterilization, according to procedures known in the art. Equipment such as Stock Rotomat Rotational retorts can be used (available from Stock America, Grafton, Wis.). Alternatively, it is contemplated that the soup contents can be sterilized by a heat exchanger under aseptic conditions and then filled into containers.

The product is sterilized by heating between about 240° F. (116° C.) and about 260° F. (127° C.), and rotating from about 5 to about 30 RPM for between about 10 and about 60 minutes. Rotational retorts are preferred as opposed to static retorts in order to reduce processing time.

The process of the present invention results in a product that exhibits a stable viscosity for uniform filling of the containers and acceptable viscosity for extended shelf life, as determined by visual phase separation or gelling observed by the naked eye. The product is stable in terms of texture and freeze thaw stability. The product can be frozen, then thawed, and evaluated for gel formation and phase separation. Specifications for visual acceptability, such as a visible phase separation or gelation, may be established.

The following are non-limiting examples of the present invention used in two different soups.

### EXAMPLE 1

Corn Chowder

In a powder slurry kettle, 27.5 pounds (57.8 kg) of Novation 2300OC organic starch (1.8% of total composition (TC)) (National Starch and Chemical Company, Bridgewater, N.J.) is admixed with 60.3 pounds (27.3 kg) of organic dry ingredients comprising non-fat dry milk powder, sugar, salt, and spices to form a dry admixture. The dry admixture is mixed with the starch component, organic corn puree (127.5 lbs.; 57.8 kg), water (683.2 lbs.; 309.5 kg), and organic butter (7.5 lbs.; 3.4 kg). Additional water (100.5 lbs.; 45.5 kg) is added to form the desired slurry.

The slurry is pumped to an agitated steam jacketed kettle, mixed and heated to 160-210° F. (71-99° C.) for twenty minutes. Bulky vegetables that have been individually quick frozen (450 lbs.; 203.9 kg) are then added to the agitated steam jacketed kettle. Organic light cream (45 lbs.; 20.4 kg) is added, and the soup is heated to 160° F. (71° C.). The bulk soup is pumped to a surge kettle, thoroughly mixed, pumped to a filler, and glass jars are filled with the product. The containers are retorted in a rotational retort at 240-260° F. (116-127° C.), at a rotational speed of 2-30 RPM for 10-60 minutes. After cooling and labeling, the product is a ready-to-serve, shelf-stable soup ready for the marketplace.

EXAMPLE 2

Ginger Carrot Soup

In a powder slurry kettle, 27.5 pounds of Novation 2300OC organic starch (1.8% of total composition (TC)) (National Starch and Chemical Company, Bridgewater, N.J.) is admixed with 33.75 pounds of organic dry ingredients (2.25% of TC) comprising sugar (16.5 lbs., 1.1% of TC) and salt (17.25 lbs., 1.15% of TC) to form a dry admixture. The dry admixture is mixed with the starch component, organic carrot puree (495 lbs., 33% of TC), organic ginger puree (18.75 lbs., 1.25% of TC), and water (345 lbs., 23% of TC). Additional water (342 lbs., 22.8% of TC) is added to form the desired slurry.

The slurry is pumped to an agitated steam jacketed kettle, mixed and heated to 195-205° F. for twenty minutes. In a separate steam jacketed kettle, organic dry wild rice (21 lbs., 1.4% of TC) and organic dry brown rice (21 lbs., 1.4% of TC) are then added to the agitated steam jacketed kettle while the composition is blanched at a boil for 30 minutes. Organic light cream (13.5 lbs., 0.9% of TC), organic onions (135 lbs., 9% of TC), organic blanched wild rice (49.5 lbs., 3.3% of TC), organic blanched brown rice (49.5 lbs., 3.3% of TC), and organic dill (0.75 lbs., 0.05% of TC) are added, and the soup is heated to 160° F. The bulk soup is pumped to a surge kettle, thoroughly mixed, pumped to a filler, and glass jars are filled with the product. The containers are retorted in a rotational retort at 240-260° F., at a rotational speed of 2-30 RPM for 10-60 minutes. After cooling and labeling, the product is a ready-to-serve, shelf-stable soup ready for the marketplace.

What is claimed:

1. A process for manufacturing a soup, comprising the steps of:
forming an admixture of dry ingredients and a physically-modified, plant-derived starch, the starch being able to withstand temperatures of 260° F.;
adding one or more liquid ingredients to the admixture to form a powder slurry;
heating the powder slurry at a sufficient temperature for a sufficient time to allow swelling of the starch to form a swelled soup base; and
adding bulky ingredients to the swelled soup base to form a bulk soup.

2. The process of claim 1, further comprising sterilizing the bulk soup to form shelf-stable soup.

3. The process of claim 1, wherein the heating the powder slurry step is performed for about 15 minutes at about 92° C., and a 5% heated slurry of the starch has the viscosity of 250-500 BU at 92° C. and 425-625 BU at 92° C. after 15 minutes.

4. The process of claim 1, wherein the starch is made from organically-grown corn or maize.

5. The process of claim 1, wherein the swelled soup base has a viscosity of about 10 cm to about 23 cm.

6. The process of claim 1, further comprising, prior to the adding step, the step of precooking the bulky ingredients.

7. The process of claim 1, further comprising the steps of filling containers with the bulk soup and sterilizing by retorting the containers.

8. The process of claim 1, wherein the swelled soup base is made by heating the slurry to between about 160° F. and about 200° F.

9. The process of claim 8, wherein the swelled soup base is heated for about twenty minutes.

10. The process of claim 7, further comprising, prior to the filling step, the step of preheating the bulk soup to about 160° F.

11. The process of claim 1 wherein the liquid ingredients are selected from the group consisting of water, broth, juice, liquid dairy products, and vegetable purees.

12. A process for filling a plurality of containers with a homogeneous mixture of soup, comprising:
forming a slurry of a physically modified starch and a liquid;
heating the slurry at a sufficient temperature for a sufficient time to allow substantial swelling of the starch to form a swelled base;
filling containers with the swelled base; and
sterilizing the swelled base in the containers.

13. The process of claim 12, further comprising, prior to the filling step, the steps of adding bulky ingredients to the swelled base and mixing to form a generally homogeneous bulk soup.

14. The process of claim 13, further comprising, prior to the adding step, the step of precooking the bulky ingredients.

15. The process of claim 14, wherein the bulky ingredients are selected from the group consisting of vegetables, legumes, barley, bulgur wheat, fruits, beans, pasta, and rice.

16. The process of claim 12, wherein the slurry is heated to between about 160° F. and about 200° F.

17. The process of claim 16, wherein the slurry is heated for between about 15 and about 30 minutes.

18. The process of claim 12, wherein the slurry is heated for about twenty minutes.

19. The process of claim 12, wherein the slurry is heated to about 195° F. for about twenty minutes.

20. The process of claim 13, further comprising, prior to the filling step, the step of heating the bulk soup to about 160° F.

21. A process for making organic soup, comprising:
making a slurry from a physically modified plant-derived starch and a liquid;
heating the slurry at a sufficient temperature and for a sufficient time to form a swelled soup base;
mixing precooked bulky organic ingredients with the swelled soup base to form bulk soup; and
sterilizing the bulk soup.

22. The process of claim 21, wherein the slurry is heated to between about 160° F. and about 200° F.

23. The process of claim 22, wherein the slurry is heated to about 195° F.

24. The process of claim 21, wherein the slurry is heated for about twenty minutes.

25. The process of claim 21, further comprising, prior to the sterilizing step, the steps of preheating the bulk soup and filling glass containers with the preheated bulk soup.

26. A soup product made according to the process comprising the steps of:
forming a slurry of a physically modified starch and a liquid;
heating the slurry at a sufficient temperature for a sufficient time to allow substantial swelling of the starch to occur, to form a swelled base;
filling containers with the swelled base; and
sterilizing the swelled base in the containers to form a soup product.

27. A soup product made according to the process comprising the steps of:
making a slurry from a physically modified plant-derived starch and a liquid;
heating the slurry at a sufficient temperature and for a sufficient time to form a swelled soup base;
mixing precooked bulky organic ingredients with the swelled soup base to form bulk soup; and
sterilizing the bulk soup to form a soup product.

28. A soup composition comprising:
from about 0.2% to about 4% by weight of a physically modified plant-derived starch;
a liquid component of about 40% to about 60% by weight; and
about 5% to about 50% bulky ingredients, the bulky ingredients being suspended in a generally homogeneous composition, wherein the bulky ingredients do not phase separate and do not settle in the generally homogenous composition for a predetermined period of time.

29. The soup composition of claim 28, wherein the soup composition is contained in a transparent container and preserved by sterilization for the predetermined period of time.

30. The soup composition of claim 28, wherein the starch is made from organically-grown corn or maize.

31. The soup composition of claim 28, wherein the bulky ingredients are selected from the group consisting of organic vegetables, legumes, bulgur wheat, barley, fruits, rice, and pasta.

32. The soup composition of claim 28, wherein the soup composition is organic.
